(19) United States
(12) Patent Application Publication
(10) Pub. No.: US 2023/0259985 A1
(43) Pub. Date: Aug. 17, 2023

(54) CHECK IN AND CHECK OUT SYSTEM, DEVICE, AND METHOD TO ACCOUNT FOR PHYSICAL ITEMS

(71) Applicants: Kathleen MCGUINNESS, Huntington, NY (US); Garrett MCGUINNESS, Huntington, NY (US)

(72) Inventors: Kathleen MCGUINNESS, Huntington, NY (US); Garrett MCGUINNESS, Huntington, NY (US)

(21) Appl. No.: 18/110,738

(22) Filed: Feb. 16, 2023

Related U.S. Application Data
(60) Provisional application No. 63/310,786, filed on Feb. 16, 2022.

(51) Int. Cl. G06Q 30/02; G06Q 30/0645

(52) U.S. Cl. CPC G06Q 30/0278; G06Q 30/0645

(57) ABSTRACT

An electronic device to account for one or more items on a list is provided. The electronic device includes a controller operatively connected to a storage unit storing instructions that, when executed, cause the controller to generate the list of the one or more items verified by a first person, determine whether a first confirmation is received from a second person indicating that the list is accurate, in response to receiving the first confirmation that the list is accurate, receive updated verification information of the one or more items on the list from the first person after a predefined period of time, and determine whether a second confirmation is received from the second person indicating that the updated verification information of the one or more items is accurate.

### CROSS REFERENCE TO RELATED APPLICATION(S)

This application is based on and claims priority under 35 U.S.C. § 119 to Provisional Patent Application No. 63/310,786, filed on Feb. 16, 2022, in the United States Patent and Trademark Office, the disclosure of which is incorporated by reference herein in its entirety.

### BACKGROUND

### 1. Field

The present disclosure generally relates to a system and device for conveniently accounting for a predetermined list of items.

### 2. Description of Related Art

Homeowners who frequently rent their homes to guests as a source of additional income often face the challenge of keeping track of all the physical property provided with the house. Such items, such as towels, kitchenware, and blankets, can easily be taken or damaged without the homeowner’s knowledge, reducing the value of the rental property. Currently, homeowners need to be physically present during check-in and check-out to ensure that all physical property is accounted for. Another option is to hire a management company, but this comes at a significant cost.

To address these challenges, there is a need for a system, device, and method that allows guests to check in and check out of a rental property without the homeowner’s immediate presence at the time of checking out, to accurately keep track of items in the physical property. The solution should eliminate the need for the homeowner or a representative to be present to account for the items at the physical property when checking in or checking out, providing a more convenient and efficient way to manage a rental property.

### SUMMARY

The present disclosure has been made to address the above-mentioned problems and disadvantages, and to provide at least the advantages described below.

In accordance with an aspect of the disclosure, an electronic device to account for one or more items on a list is provided. The electronic device includes a controller operatively connected to a storage unit storing instructions that, when executed, cause the controller to generate the list of the one or more items verified by a first person, determine whether a first confirmation is received from a second person indicating that the list is accurate, in response to receiving the first confirmation that the list is accurate, receive updated verification information of the one or more items on the list from the first person after a predefined period of time, and determine whether a second confirmation is received from the second person indicating that the updated verification information of the one or more items is accurate.

In accordance with another aspect of the disclosure, a method to account for one or more items on a list is provided. The method includes generating the list of the one or more items verified by a first person, determining whether a first confirmation is received from a second person indicating that the list is accurate, in response to receiving the first confirmation that the list is accurate, receiving updated verification information of the one or more items on the list from the first person after a predefined period of time, and determining whether a second confirmation is received from the second person indicating that the updated verification information of the one or more items is accurate.

In accordance with another aspect of the disclosure, a system to account for one or more items on a list includes a list generator configured to generate the list of the one or more items verified by a first person; at least one confirmation detector configured to determine whether a first confirmation is received from a second person indicating that the list is accurate; and an update verification module configured to receive updated verification information of the one or more items on the list from the first person after a predefined period of time, wherein the at least one confirmation detector is configured to determine whether a second confirmation is received from the second person indicating that the updated verification information of the one or more items is accurate.

### BRIEF DESCRIPTION OF THE DRAWINGS

The above and other aspects, features, and advantages of certain embodiments of the present disclosure will be more apparent from the following description, taken in conjunction with the accompanying drawings, in which:

FIG. 1 illustrates an electronic device for storing a list of items, according to an embodiment; and

FIG. 2 illustrates a method of using an electronic device in a home renting situation, according to an embodiment.

### DETAILED DESCRIPTION

The present invention enables owners of property to better account for items located at the property after the property is rented, borrowed, leased, or otherwise used by somebody else.

A system, method and device that accounts for physical items in a property used by somebody else can help streamline many processes and provide several benefits, such as improved inventory management, faster move-in/move-out processes, improved record keeping, and increased transparency.

Inventory management may be improved by embodiments disclosed herein because a user can keep an accurate and up-to-date inventory of all the physical items in a property that are used by another person. This makes it easier to track the status of each item and ensure that a complete record of what is in the property is provided.

Faster move-in/move-out processes may be accomplished by automating many of the tasks involved in move-in and move-out processes. For example, embodiments disclosed herein be used to generate a list of items in the property and compare it against what was present at a prior mutually agreed upon time (e.g., a check-in time). This helps to quickly identify any missing or damaged items, which can save time and improve the efficiency of the move-out process.

Record keeping can be improved because the system and device disclosed herein can store detailed information about each item, including its condition, value, and maintenance history. This makes it easy to keep accurate records and have all the information necessary to make informed decisions about maintenance, repairs, and replacement of items.

Increased transparency can also be provided by the system and device. For example, the system and device disclosed herein can provide a clear and transparent record of the status of items in the property used by another person. This can help to reduce disputes and misunderstandings between landlords and tenants and promote trust and cooperation between all parties.

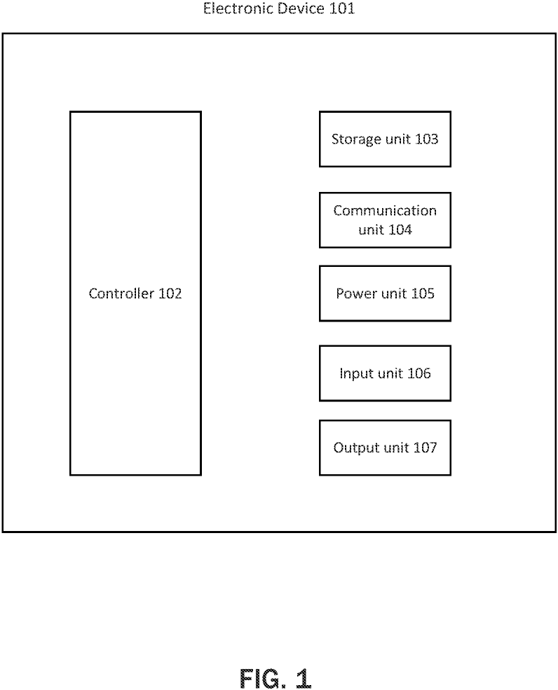

FIG. 1 illustrates an electronic device for storing a list of items, according to an embodiment. One or more of the components illustrated in FIG. 1 may or may not be necessary to include in the electronic device 101 to accomplish and perform the present invention. Also, additional components may be added.

Referring to FIG. 1, the electronic device 101 may be any handheld portable electronic device, such as a tablet, computer, or mobile phone.

The term “unit” (or “module”) is a general term that can refer to a single and distinct component of a larger system or structure. In the context of software and hardware, a unit can refer to a specific software program, a hardware component, or a combination of both. For example, a “unit” may be a device, a structural component of a device, or a portion of a device connected and integrated to form a larger system.

Referring to FIG. 1, the electronic device 101 includes a controller 102 (e.g., a processor). The electronic device 101 may store instructions in the storage unit 103 or elsewhere (e.g., in the cloud or in an exterior storage device) to control the controller 102 to perform a set of tasks when the instructions are executed. The electronic device 101, and its components, may include the structural features necessary to perform embodiments of the present disclosure (e.g., the electronic device 101 may include a list generator, a confirmation detector, an update verification module, a confirmation detector, and/or a reimbursement module).

The storage unit 103 may include a random access memory or a read only memory and/or be wirelessly connected to external cloud storage devices over the Internet or a local intranet using a communication unit 104.

The electronic device 101 includes a power unit 105 for supplying power to the electronic device 101. The power unit 105 may be a one-time use battery, a rechargeable battery, or connected to a wall power source.

The electronic device 101 includes an input unit 106 for receiving information and an output unit 107 for outputting information. The input unit 106 may include, for example, a touch screen interface, a keyboard, a mouse, a camera, a sensor, a voice recognition system, and/or a stylus pen. The output unit may include a screen display, a projector, or an audio output system. In addition, structural components necessary to conduct a live video (e.g., such as live video meeting including live audio) can be used to satisfy the function of the input unit 106 and/or the output unit 107.

The electronic device 101 may access an application having instructions for controlling the controller 102. The application may be stored in the storage unit 103 or accessed via the wireless connection. When opened, the application may connect to the Internet to retrieve updated information. The application may provide a predetermined list of items that correspond to a property used by another person (e.g., the application may request a predetermined list from a server and the predetermined list may be transmitted from the server to the electronic device 101). For example, if the property is a home, then the list of items may include, for example, 4 hand towels, 8 glasses, 8 plates, 10 pillows, 4 blankets, as well as other household items. In addition, any items may be included on the list so long as they are associated with the property used by another person.

Additionally, the application may provide one or more pictures or videos of each item on the list so as to ascertain the condition of the item. Also, the electronic device 101 may include a camera or sensor for capturing an image or video and determining a condition of the item.

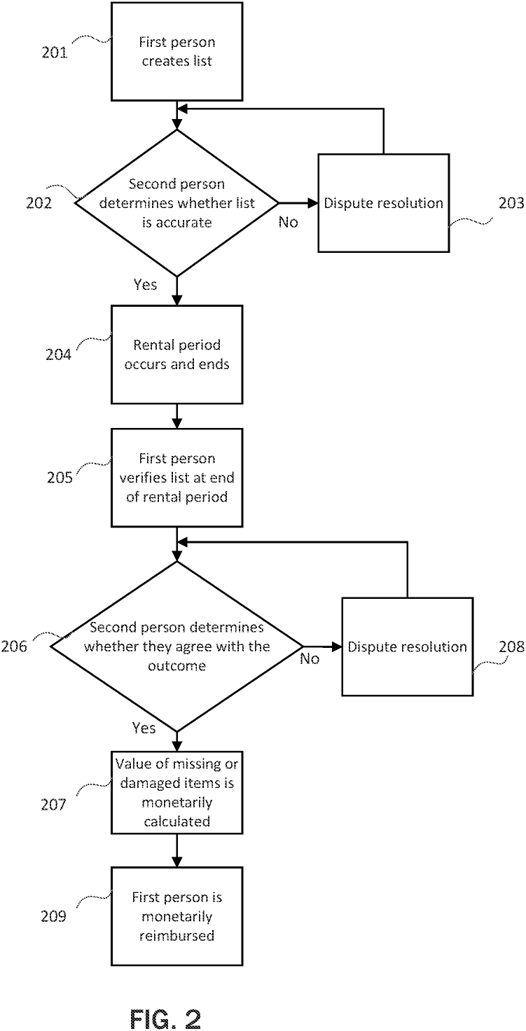

FIG. 2 illustrates a method of using an electronic device in a home renting situation, according to an embodiment.

A first person (e.g., a home owner) and a second person (e.g., a home renter) may each possess one instance of the application on respective electronic devices.

Referring to FIG. 2, prior to renting a home, a homeowner may wish to account for items in the home. The home owner may access the application via the homeowner’s electronic device 101. The application may provide a user interface for the home owner to provide authentication information to verify that he or she is the home owner. Once authenticated, the home owner may access and/or create various lists corresponding to different properties. The first person (home owner) may select a property and create a list corresponding to that property in step 201. Alternatively, the home owner may manipulate a list that was previously created. The home owner may add or remove items from the list. As mentioned above, the items may correspond to physical items in the home. The home owner may use a camera on the electronic device 101 to capture an image or a video of an item on the list.

Once the home owner has completed formulating the list of items, the home owner may be ready to rent the home to the home renter (second person).

Prior to taking possession of the home, the home renter may access the application via the home renter’s electronic device 101. The home renter may provide authentication information to access the list of items associated with the property of the home owner. The second person (home renter) may use the list to determine whether the list is accurate in step 202. The second person may determine whether each of the items on the list are physically present at the property and/or in the state indicated on the list by the first person. For example, prior to beginning a rental, the home renter may verify that 4 hand towels, 8 glasses, 8 plates, 10 pillows, 4 blankets, as well as other household items, are physically present at the property and/or a state of the items is accurate (e.g., each item is in good condition). The home renter may use a camera on the electronic device 101 to capture a photo or video to verify the state of one or more of the items.

In step 202, if the home renter indicates that the list is not accurate (No in step 202), then in step 203, dispute resolution occurs. For example, if the home renter notices that an item is not correctly accounted for on the list (e.g., if there are 7 glasses instead of 8), then the home renter can mark it on the list for the home owner to review. The home renter may also use the camera to take a picture or video of the item to allow the home owner to conveniently review the dispute. The original terms of the rental agreement may be used to help resolve the dispute. Once the dispute is resolved, the method returns to step 202.

Once the home renter verifies that the list is accurate (Yes in step 202), then the home renting may proceed in step 204, and the rental period occurs and ends.

After the home rental period has ended, the home owner may use the verified list to account for all of the items on the list in step 205. For example, the home owner may walk through the home and physically inspect each item on the list to determine if it is accounted for and in the proper state. Alternatively, the home owner can remotely verify the condition of each of the items on the list using cameras and/or sensors, or using a live video chat with the renter or another person for verification.

In step 206, the home renter determines whether they agree with the outcome. That is, the home renter may review the first person’s assessment of the list (from step 205), and decide whether each of the items on the list are accurately accounted for by the first person (e.g., the physical presence and condition of each of the items is accurately stated). If the home renter determines that they do not agree with the first person’s assessment of the list (No in step 206), then in step 208, dispute resolution occurs. The first person and the second person may discuss the disagreement and attempt to reach a mutually agreeable resolution. A written rental agreement may be used to help resolve the disagreement. In addition, a third party (e.g., an arbitrator) can be used to help resolve the disagreement. The disagreement may be resolved virtually or in person. Once the disagreement is resolved in step 208, the method returns to step 206.

If the home renter agrees with the outcome in step 206 (Yes in step 206), then in step 207, the value of the missing or damaged items is monetarily calculated. The determine the value of the missing or damaged items, the original (signed) rental agreement may be used. Other well-known forms of monetary valuation can be used as well.

In step 209, the home owner is monetarily reimbursed for the valued of the missing or damaged items calculated in step 207. For example, the home owner may be immediately reimbursed from the home renter’s monetary deposit for the rental house.

The abovementioned example is not limited to home owners or home renters (e.g., vehicle rentals or other property rentals may also be applied to the present invention), and the types of items may include any item associated with the property (e.g., if a computer is rented, then an item may be a program that is stored on the computer).

Additionally, the application may provide other helpful information to the renter. For example, the application can provide instructions for using a thermostat, instructions for using a pool heater, a list of other things/experiences that the renter may access, a condition of a home, local contacts, or activities.

The renter may be incentivized to use the application disclosed herein because it may reduce hidden renting charges due to lost or damaged property, and the application may provide a clear and professional understanding and agreement. Use of the application may also ensure that the renter’s security deposit is returned by avoiding miscalculations and/or owner overcharging. In addition, the application may provide a means for the renter to verify and account for items on the list upon checkout. Additionally, the application may provide a means for the user to provide a recommendation or ratings of the property and/or the owner.

Also, the home or property owner (or his/her agent or broker) may benefit from the application disclosed herein because he or she may not necessarily need to meet the renter in-person since the renter can verify the contents of the list virtually. Also, the application may allow the owner to easily account for and calculate the value of any items that should be deducted from the renter’s security deposit.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. An electronic device to account for one or more items on a list, the electronic device comprising:
a controller operatively connected to a storage unit storing instructions that, when executed, cause the controller to:
generate the list of the one or more items verified by a first person,
determine whether a first confirmation is received from a second person indicating that the list is accurate,
in response to receiving the first confirmation that the list is accurate, receive updated verification information of the one or more items on the list from the first person after a predefined period of time, and
determine whether a second confirmation is received from the second person indicating that the updated verification information of the one or more items is accurate.

2. The electronic device of claim 1, wherein generating the list of the one or more items verified by the first person comprises assigning a state or condition to each of the one or more items on the list.

3. The electronic device of claim 2, wherein determining whether the first confirmation is received from the second person indicating that the list is accurate comprises determining whether information is received that indicates that the state or condition assigned to each of the one or more items on the list is accurate.

4. The electronic device of claim 2, wherein the updated verification information indicates whether the state or condition of each of the one or more items on the list has changed.

5. The electronic device of claim 1, wherein the instructions, when executed, further cause the controller to:
when the second confirmation indicates that the updated verification information is accurate, determine whether at least one of the one or more items on the list are damaged or missing,
calculate a monetary value of the one or more damaged or missing items on the list in response to determining that at least one of the one or more items on the list are damaged or missing, and reimburse the first person based on the monetary value of the at least one damaged or missing items, and
return a monetary deposit to the second person in response to determining that at least one of the one or more items on the list are not damaged or missing.

6. The electronic device of claim 5, wherein the monetary value is calculated based on a predefined set of prices when it is determined that at least one of the one or more items on the list are damaged or missing.

7. A method to account for one or more items on a list, the method comprising:
generating the list of the one or more items verified by a first person;
determining whether a first confirmation is received from a second person indicating that the list is accurate;
in response to receiving the first confirmation that the list is accurate, receiving updated verification information of the one or more items on the list from the first person after a predefined period of time; and
determining whether a second confirmation is received from the second person indicating that the updated verification information of the one or more items is accurate.

8. The method of claim 7, wherein generating the list of the one or more items verified by the first person comprises assigning a state or condition to each of the one or more items on the list.

9. The method of claim 8, wherein determining whether the first confirmation is received from the second person indicating that the list is accurate comprises determining whether information is received that indicates that the state or condition assigned to each of the one or more items on the list is accurate.

10. The method of claim 8, wherein the updated verification information indicates whether the state or condition of each of the one or more items on the list has changed.

11. The method of claim 1, further comprising:
when the second confirmation indicates that the updated verification information is accurate, determining whether at least one of the one or more items on the list are damaged or missing;
calculate a monetary value of the one or more damaged or missing items on the list when it is determined that at least one of the one or more items on the list are damaged or missing, and reimburse the first person based on the monetary value of the at least one damaged or missing items; and
return a monetary deposit to the second person when it is determined that at least one of the one or more items on the list are not damaged or missing.

12. The method of claim 11, wherein the monetary value is calculated based on a predefined set of prices when it is determined that at least one of the one or more items on the list are damaged or missing.

13. A system to account for one or more items on a list, the system comprising:
a list generator configured to generate the list of the one or more items verified by a first person;
at least one confirmation detector configured to determine whether a first confirmation is received from a second person indicating that the list is accurate; and
an update verification module configured to receive updated verification information of the one or more items on the list from the first person after a predefined period of time, wherein the at least one confirmation detector is configured to determine whether a second confirmation is received from the second person indicating that the updated verification information of the one or more items is accurate.

14. The system of claim 13, wherein generating the list of the one or more items verified by the first person comprises assigning a state or condition to each of the one or more items on the list.

15. The system of claim 14, wherein determining whether the first confirmation is received from the second person indicating that the list is accurate comprises determining whether information is received that indicates that the state or condition assigned to each of the one or more items on the list is accurate.

16. The system of claim 14, wherein the updated verification information indicates whether the state or condition of each of the one or more items on the list has changed.

17. The system of claim 13, further comprising:
a payment module, configured to:
when the second confirmation indicates that the updated verification information is accurate, determine whether at least one of the one or more items on the list are damaged or missing,
calculate a monetary value of the one or more damaged or missing items on the list in response to determining that at least one of the one or more items on the list are damaged or missing, and reimburse the first person based on the monetary value of the at least one damaged or missing items, and
return a monetary deposit to the second person in response to determining that at least one of the one or more items on the list are not damaged or missing.

18. The system of claim 17, wherein reimbursing the monetary value is calculated based on a predefined set of prices when it is determined that at least one of the one or more items on the list are damaged or missing.
